(19) United States
(12) Patent Application Publication
(10) Pub. No.: US 2025/0065707 A1
(43) Pub. Date: Feb. 27, 2025

(54) Wheel Hub Drive for a Motor Vehicle, in Particular for a Car, and a Motor Vehicle

(71) Applicant: Mercedes-Benz Group AG, Stuttgart (DE)

(72) Inventors: Wolfgang ELSER, Weil der Stadt (DE); Ernst WALTH, Heilbronn (DE)

(21) Appl. No.: 18/722,199

(22) PCT Filed: Dec. 14, 2022
(86) PCT No.: PCT/EP2022/085936

§ 371 Date: Jun. 20, 2024

(30) Foreign Application Priority Data
Jan. 3, 2022 (DE) 10 2022 000 035.0

(51) Int. Cl. B60K 7/00; B60K 17/02

(52) U.S. Cl. CPC B60K 7/0007; B60K 17/02; B60K 2007/0038

(57) ABSTRACT

A wheel hub drive for a motor vehicle has a wheel carrier, a wheel hub rotatably mounted on the wheel carrier via a wheel bearing, to which wheel hub a vehicle wheel of the motor vehicle can be connected in a rotationally fixed manner, an electric machine which has a stator connected to the wheel carrier in a rotationally fixed manner and a rotor that can be driven via the stator and can thus be rotated in relation to the stator, which rotor is mounted rotatably on the wheel hub via a rotor bearing, and a form-fit coupling device which can be switched between a coupling state, in which the rotor is connected to the wheel hub in a form-fit and rotationally fixed manner by the coupling device, and a decoupling state, in which the rotor can be rotated in relation to the wheel hub.

### BACKGROUND AND SUMMARY OF THE INVENTION

The invention relates to a wheel hub drive for a motor vehicle, in particular for a car. Furthermore, the invention relates to a motor vehicle, in particular a car, having at least one such wheel hub drive.

A small vehicle, in particular a wheelchair, is known from DE 41 27 257 A1, having a frame with at least two running wheels, which can each be driven with transmission by means of a direct current motor arranged in the region of their hub.

The object of the present invention is to create a wheel hub drive for a motor vehicle and a motor vehicle having such a wheel hub drive, such that a particularly efficient operation can be achieved.

A first aspect of the invention relates to a wheel hub drive for a motor vehicle, in particular for a car. This means that the motor vehicle preferably formed as a car, in particular a passenger car, has, in its completely manufactured state, the wheel hub drive. In particular, the motor vehicle, in its completely manufactured state, has at least one vehicle wheel, also simply referred to as a wheel, which is a ground contact element of the motor vehicle. The motor vehicle can be supported or is supported downwardly on a ground in the vertical direction of the vehicle via its ground contact element. If the motor vehicle is driven along the ground while the motor vehicle is supported downwardly on the ground in the vertical direction of the vehicle via the vehicle wheel, then the vehicle wheel rolls, in particular directly, on the ground. As is explained below in yet more detail, the vehicle wheel can be driven electrically, in particular entirely so, by means of the wheel hub drive, in order to thus achieve, for example, an in particular entirely electric drive of the motor vehicle.

The wheel hub drive has a wheel carrier and a wheel hub, which are rotatably mounted on the wheel carrier via a wheel bearing. Preferably, the wheel bearing is a first roller bearing. In other words, the wheel hub is mounted on the wheel carrier to be able to rotate around a wheel axis of rotation in relation to the wheel carrier, namely via the wheel bearing. Here, the previously mentioned vehicle wheel can be or is connected to the wheel hub in a rotationally fixed manner. For this, the wheel hub, for example, has a so-called rim carrier, to which the vehicle wheel, for example, in particular a rim of the vehicle wheel, can be connected in a rotationally fixed manner. In particular, the vehicle wheel can be or is connected to the wheel hub, in particular to the rim carrier, in a reversibly releasable rotationally fixed manner, such that the vehicle wheel can be connected to the wheel hub, in particular to the rim carrier, in a rotationally fixed manner and subsequently detached from the wheel hub and subsequently connected again to the wheel hub in a rotationally fixed manner, without causing damage or destruction to the wheel hub or the wheel. In particular when the motor vehicle is driven along the ground while the motor vehicle is supported downwardly on the ground in the vertical direction of the vehicle via the vehicle wheel, the wheel hub and thus the vehicle wheel rotate around the wheel axis of rotation in relation to the wheel carrier. For example, the wheel carrier is flexibly bound to a structure, formed as a self-supporting bodywork, for example, of the motor vehicle, in particular via at least one wheel guide rail, also referred to simply as guide rail, such that the wheel carrier and thus the vehicle wheel are guided in relation to the structure by means of the wheel guide rail. Thus, unwanted or excessive relative movements between the wheel carrier and the structure and thus between the vehicle wheel and the structure are prevented by means of the wheel guide rail. For example, the wheel carrier and thus the vehicle wheel are flexibly bound to the structure via the wheel guide rail in such a way that the wheel guide rail allows compression and rebound movements of the wheel carrier and thus the vehicle wheel occurring at least in the vertical direction of the vehicle in relation to the structure.

The vehicle wheel comprises, for example, the previously mentioned rim and a tyre, which is fitted onto the rim, for example. The rim and thus the vehicle wheel can be connected to the wheel hub, in particular to the rim carrier of the wheel hub, in a rotationally fixed manner, in particular by means of several wheel screws. Moreover, the wheel hub drive has in particular exactly one electric machine, which has a stator connected to the wheel carrier in a rotationally fixed manner and a rotor. The rotor can be driven by means of the stator, in particular using electrical energy, and thus can be rotated in relation to the stator, in particular around an machine axis of rotation. In particular, the rotor is arranged coaxially to the wheel hub, such that the machine axis of rotation preferably coincides with the wheel axis of rotation. In particular, the rotor can be driven by means of the stator and thus can be rotated in relation to the wheel carrier around the machine axis of rotation, in particular the wheel axis of rotation. As is explained below in yet more detail, the wheel hub and thus the vehicle wheel can be driven by means of the rotor by driving the rotor and thus can be rotated in relation to the wheel carrier, in particular around the wheel axis of rotation. Thus, the electric machine can provide at least one drive torsional moment via its rotor, by means of which drive torsional moment the wheel hub and thus the vehicle wheel can be driven and thus rotated around the machine axis of rotation and/or around the wheel axis of rotation in relation to the wheel carrier and, in particular, also in relation to the structure.

The rotor is mounted rotatably on the wheel hub via, in particular at least or exactly, one rotor bearing provided in addition to the wheel bearing. Preferably, the rotor bearing is formed as a second roller bearing. This means that the rotor is mounted on the wheel hub via the rotor bearing to be able to rotate around the machine axis of rotation and thus preferably around the wheel axis of rotation in relation to the wheel hub. Thus, it is conceivable, in particular, that the rotor and the wheel hub can be rotated around the machine axis of rotation or around the wheel axis of rotation in relation to each other. Moreover, the rotor can rotate around the machine axis of rotation and/or around the wheel axis of rotation in relation to the wheel carrier, and the wheel hub can rotate around the wheel axis of rotation in relation to the wheel carrier.

Moreover, the wheel hub drive has a form-fit coupling device, which can be switched between a coupling state and a decoupling state, in particular by using electrical energy and/or hydraulically and/or pneumatically. In the coupling state, the rotor is connected to the wheel hub in a form-fit and rotationally fixed manner by means of the coupling device, such that, in the coupling state, the rotor and the wheel hub can rotate or do rotate around the wheel axis of rotation or around the machine axis of rotation, in particular together or simultaneously, with the same angular speed, in particular when the rotor and, via the rotor, the wheel hub are driven by means of the stator. In the decoupling state, the rotor can be rotated in relation to the wheel hub, in particular around the machine axis of rotation or around the wheel axis of rotation, or vice versa. In other words, in the decoupling state, the coupling device allows relative rotations taking place around the wheel axis of rotation or around the machine axis of rotation between the rotor and the wheel hub, such that, in the decoupling state, the rotor is decoupled from the wheel hub or vice versa. If, for example, in the decoupling state, the vehicle wheel and, with the vehicle wheel, the wheel hub thus rotate around the wheel axis of rotation or around the machine axis of rotation in relation to the wheel carrier, then in doing so the rotor is not driven by the wheel hub, and therefore the wheel hub does not entrain the rotor, such that a particularly efficient operation can be featured. In other words, a particularly high degree of efficiency of the wheel hub drive can be featured, such that a particularly high electrical range, via which the vehicle wheel can be driven by means of the wheel hub drive by using electrical energy, can be featured. The wheel hub drive is an electrical traction drive, since the vehicle wheel and thus the vehicle can be driven electrically, in particular entirely so, by means of the wheel hub drive. In particular due to the fact that the rotor can be decoupled from the wheel hub, losses, in particular by drag moments, can be kept particularly low, such that a particularly high degree of efficiency of the wheel hub drive can be featured. In comparison to conventional solutions, a rotationally fixed connection between the rotor and the wheel hub is dissolved and replaced by the coupling device, in particular, which can be switched between the decoupling state and the coupling state as needed. It has been found that, in comparison to a wheel hub drive in which the rotor is permanently connected to the wheel hub in a rotationally fixed manner, a range gain of several percentage points can be achieved. For example, as a result of the wheel hub drive according to the invention, a connectable and disconnectable all-wheel drive of the motor vehicle can be achieved. For example, in its completely manufactured state, the motor vehicle has at least or exactly two vehicle axles, also referred to simply as axles, arranged one after the other in the longitudinal direction of the vehicle, wherein the respective vehicle axle has at least or exactly two vehicle wheels. The respective vehicle wheels of the respective axle are arranged, for example, on sides of the motor vehicle lying opposite one another in the transverse direction of the vehicle. One of the vehicle wheels is the previously mentioned vehicle wheel that can be driven by means of the wheel hub drive and is also referred to as the first vehicle wheel. The first vehicle wheel is one of the vehicle wheels of a first of the axles, and the first axle has the first vehicle wheel and a second of the vehicle wheels. Here, the second vehicle wheel, for example, can be driven by means of a further wheel hub drive, wherein the previous and following statements relating to the first wheel hub drive and to the first vehicle wheel can also be readily transferred to the further wheel hub drive and the second vehicle wheel. The vehicle wheels of the second axle are also referred to as third vehicle wheels and can be driven, for example, by means of at least one drive motor provided in addition to the wheel hub drives, wherein the drive motor can be, for example, an internal combustion machine or even a further electric machine. In order to drive the first vehicle wheel and the second vehicle wheel, for example, by means of the wheel hub drives, in particular in addition to the third vehicle wheels being driven by means of the drive motor, the respective wheel hub is connected to the respective rotor in a rotationally fixed manner by means of the respective coupling device. To do so, the at least or exactly four vehicle wheels can be driven, whereby a four-wheel drive and thus the previously mentioned all-wheel drive can be achieved, i.e., is activated or connected. If the all-wheel or four-wheel drive is disconnected, then the respective coupling device is in its respective decoupling state. If the third vehicle wheels are then driven by means of the drive motor, whereby the motor vehicle is driven, such that the four vehicle wheels, for example, roll on the previously mentioned ground, then the first vehicle wheel and the second vehicle wheel or the wheel hubs of the wheel hub drives do not entrain the rotors, whereby a particularly efficient operation can be achieved. In particular, when the coupling devices are in their decoupling states while the third vehicle wheels are driven by means of the drive motor, the motor vehicle can be driven in an energy-saving manner and thus over a particularly high, in particular electric, range, since the wheel hubs of the wheel hub drives do not entrain the rotors of the wheel hub drive.

Moreover, due to the fact that the coupling device is formed as a form-fit coupling device, losses in the wheel hub drive can be kept particularly low, such that a particularly high degree of efficiency can be featured.

In order to be able to couple the rotor to the wheel hub particularly efficiently and in a manner that is favourable in terms of structure space and weight, it is provided in a design of the invention that the coupling device has in particular at least or exactly one first coupling toothing connected to the rotor in a rotationally fixed manner and in particular at least or exactly one wide coupling toothing connected to the wheel hub in a rotationally fixed manner. In the coupling state, the rotor is connected to the wheel hub in a form-fit and rotationally fixed manner by means of the coupling toothings.

A further design of the invention is characterized in that the first coupling toothing is arranged on a radially inner end and axially on a side of the rotor facing towards a motor vehicle inner region, in particular in the installation position of the wheel hub drive, which assumes its installation position in the completely manufactured state of the motor vehicle equipped with the wheel hub drive. In other words, it is preferably provided that the first coupling toothing is arranged on a lateral surface of the rotor on the inner peripheral side and pointing radially inwards, for example, in the radial direction of the wheel hub drive, whereby a structure that is particularly favourable in terms of construction space can be featured. Moreover, the first coupling toothing is arranged on the side of the rotor facing towards the motor vehicle inner region when seen in the axial direction of the wheel hub drive and here, in particular, on a side of the wheel hub pointing inwards when seen in the axial direction of the wheel hub drive and thus pointing to the wheel carrier. The axial direction of the wheel hub drive runs along the machine axis of rotation or along the wheel axis of rotation, wherein the radial direction of the wheel hub motor runs perpendicularly to the axial direction of the wheel hub motor and thus perpendicularly to the wheel axis of rotation or machine axis of rotation. As a result of the described arrangement of the first coupling toothing, a particularly advantageous degree of accessibility to the coupling toothing can be achieved, in particular from inwards to outwards in the axial direction of the wheel hub drive, i.e., starting from the side of the rotor. In particular, the coupling device can thus overall be particularly well accessible, such that a particularly advantageous mounting can be achieved. Moreover, the coupling device, for example, can thus be serviced and/or exchanged particularly advantageously.

In a further design of the invention, the wheel hub drive has a brake disc connected to the wheel hub in a rotationally fixed manner for a disc brake of the motor vehicle provided for braking the vehicle wheel. In doing so, a particularly safe operation can be achieved, since, in the decoupling state of the coupling device, the rotor can be rotated in relation to the wheel hub, yet the brake disc is connected to the wheel hub in a rotationally fixed manner both in the decoupling state and in the coupling state, in particular permanently. For example, the wheel hub has a so-called brake carrier, which can be connected to the rim carrier in a rotationally fixed manner. In particular, it is conceivable that the brake carrier and the rim carrier are formed integrally with each other. In other words, the brake carrier and the rim carrier are not constructed from parts formed separately from one another and connected to one another, for example, but rather the brake carrier and the rim carrier are formed from a single piece, hence from a monobloc, and are thus integral components of an integral and thus unitarily produced, unitary body. Here, the brake disc, for example, is connected to the brake carrier in a rotationally fixed manner, in particular to be reversibly detachable, and thus to the wheel hub. The feature that the brake disc is preferably permanently connected to the wheel hub in a rotationally fixed manner is to be understood to mean that a switching element is not provided, for example, which can be switched between a blocking state connecting to the wheel hub in a rotationally fixed manner and a release state, in which the brake disc can be rotated in relation to the wheel hub, but rather the brake disc is constantly, i.e., always or permanently, connected to the wheel hub in a rotationally fixed manner. Thus, a particularly high degree of safety can be featured.

In a further particularly advantageous design of the invention, at least one longitudinal region of the wheel bearing running in the axial direction of the wheel hub drive overlaps with the rotor bearing outwardly in the radial direction of the wheel hub drive, in particular completely peripherally in the peripheral direction of the wheel hub drive running around the axial direction of the wheel hub drive. In doing so, a particularly compact structure which is thus favourable in terms of construction space can be achieved, whereby a particularly high degree of efficiency can be featured.

In order to be able to achieve a particularly low weight for a particularly friction-free bearing and thus a particularly efficient operation, it is provided in a further design of the invention that the rotor bearing, in particular a bearing outer ring of the rotor bearing, is supported outwardly in the radial direction of the wheel hub drive directly on the rotor, in particular on a lateral surface of the rotor on the side of the inner periphery. The rotor bearing, in particular a bearing inner ring of the rotor bearing, is inwardly supported in the radial direction of the wheel hub drive directly on the wheel hub, in particular on a lateral surface of the wheel hub on the side of the outer periphery.

A further design of the invention is characterized in that the coupling device has an actuating element that can be shifted between at least one coupling position causing the coupling state and at least one decoupling position causing the decoupling state in the axial direction of the wheel hub drive in relation to the wheel carrier, in relation to the rotor and in relation to the wheel hub, the actuating element also being referred to as a slider. Thus, a particularly efficient actuation of the coupling device, and thus a particularly efficient switching of the coupling device between the coupling state and the decoupling state, can be achieved.

Furthermore, it has been shown to be particularly advantageous when the coupling device has an actuator, by means of which the actuation element can be shifted electrically, in particular electromagnetically, or pneumatically or hydraulically, out of the coupling position into the decoupling position and/or out of the decoupling position into the coupling position. In other words, the actuator can be operated electrically, for example, in particular electromagnetically, pneumatically or hydraulically. In doing so, the coupling device can be switched between the decoupling state and the coupling state particularly efficiently and, in particular, as needed.

To achieve a particularly high degree of efficiency, it has been shown to be particularly advantageous when a power electronics system, via which the electric machine can be supplied with electrical energy or electrical current, is connected to the wheel carrier in a rotationally fixed manner. A second aspect of the invention relates to a motor vehicle, preferably formed as a car, in particular as a passenger car, which has at least one wheel hub drive according to the first aspect of the invention. Advantages and advantageous designs of the first aspect of the invention are to be seen as advantages and advantageous designs of the second aspect of the invention, and vice versa.

Finally, it has been shown to be particularly advantageous when the actuation element forces through a corresponding through opening of the rotor, at least in the coupling position, in particular both in the coupling position and in the decoupling position. Thus, an axial reach through the rotor, in particular through a rotor carrier of the rotor, is provided for the actuation element and thus for an actuation of the coupling device, also referred to as a disconnection device. For example, the actuation element reaches through the through opening and thus the rotor, in particular the rotor carrier, in such a way that the actuation element protrudes on both sides out of the through opening and thus out of the rotor, in particular the rotor carrier, in the axial direction of the wheel hub drive, at least in the coupling position, in particular both in the decoupling position and in the coupling position. Here, the second coupling toothing, for example, is arranged on a side, in particular an outer side, of the rotor facing away from the wheel carrier in the axial direction of the wheel hub drive.

Further advantages, features and details of the invention emerge from the subsequent description of a preferred exemplary embodiment and by means of the drawings. The features and feature combinations mentioned above in the description and the features and feature combinations mentioned below in the description of the features and/or shown in the figures alone can be used not only in the respectively specified combination, but also in other combinations or on their own, without leaving the scope of the invention.

### BRIEF DESCRIPTION OF THE DRAWINGS

FIG. 1 is a schematic longitudinal sectional view of a first embodiment of a wheel hub drive for a motor vehicle;

FIG. 2, in sections, is a further schematic longitudinal sectional view of the first embodiment of the wheel hub drive;

FIG. 3, in sections, is a schematic longitudinal sectional view of a second embodiment of the wheel hub drive;

FIG. 4, in sections, is a further schematic longitudinal sectional view of the second embodiment of the wheel hub drive

FIG. 5, in sections, is a further schematic longitudinal sectional view of the second embodiment of the wheel hub drive;

FIG. 6, in sections, is a further schematic longitudinal sectional view of the second embodiment of the wheel hub drive;

FIG. 7, in sections, is a further schematic longitudinal sectional view of the second embodiment of the wheel hub drive; and

FIG. 8, in sections, is a further schematic longitudinal sectional view of the second embodiment of the wheel hub drive.

### DETAILED DESCRIPTION OF THE DRAWINGS

In the figures, the same or functionally identical elements are provided with the same reference numerals.

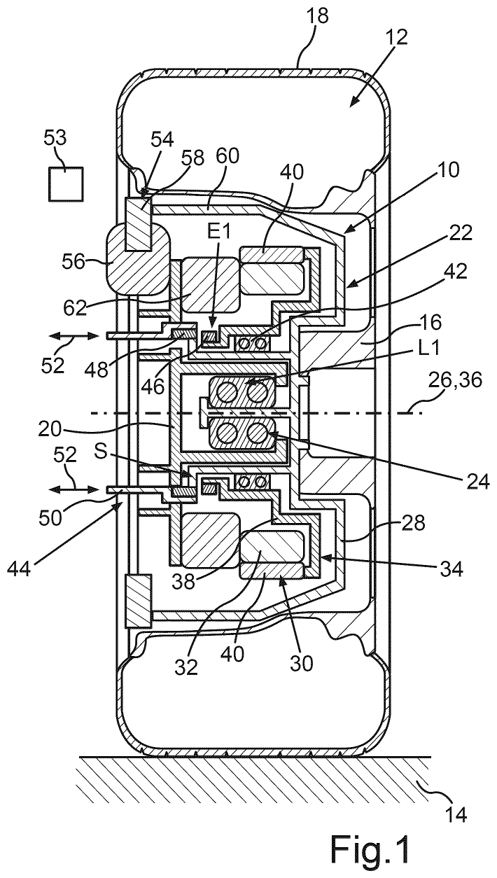

In a schematic longitudinal sectional view, FIG. 1 shows a first embodiment of a wheel hub drive 10 for a motor vehicle, which is preferably formed as a car, in particular as a passenger car. In its completely manufactured state, the motor vehicle has at least or exactly two vehicle axles arranged successively and thus one behind the other in the longitudinal direction of the vehicle and also simply referred to as axles. The respective vehicle axle has at least or exactly two vehicle wheels, which are also simply referred to as wheels. The respective vehicle wheels of the respective vehicle axle are arranged on sides of the motor vehicle opposite each other in the transverse direction of the vehicle. One of the vehicle axles has also been referred to as the first vehicle axle, and the other vehicle axle has also been referred to as the second vehicle axle. The vehicle wheels of the first vehicle axle are also referred to as first vehicle wheels, and the vehicle wheels of the second vehicle axle are also referred to as second vehicle wheels. In FIG. 1, one of the vehicle wheels of one of the axles is depicted schematically and labelled with 12. It can be seen from FIG. 1 as an example of the vehicle wheel 12 that the respective vehicle wheel is a ground contact element, wherein the motor vehicle can be supported or is supported downwardly in the vertical direction of the vehicle on a ground 14 via the ground contact elements. The vehicle wheel 12 comprises a rim 16 and a tyre 18, which is fitted onto the rim 16. For example, the vehicle wheel 12 is a first vehicle wheel of the first axle. As is explained below in yet more detail, the vehicle wheel of the first axle can be driven by means of the wheel hub drive 10. For example, a further wheel hub drive is allocated to the second vehicle wheel of the first vehicle axle, by means of which wheel hub drive the second vehicle wheel of the first vehicle axle can be driven. Here, the following and previous statements relating to the vehicle wheel 12 and the wheel hub drive 10 can also be transferred to the second vehicle wheel and the further wheel hub drive, and vice versa.

The wheel hub drive 10 comprises a wheel carrier 20, which is flexibly bound, in particular via at least one wheel guide rail, also simply referred to as a guide rail, on a structure of the motor vehicle formed, for example, as a self-supporting bodywork. An interior chamber of the motor vehicle, also referred to as a passenger cabin or passenger chamber, is delimited by the structure, wherein at least one person, such as the driver of the motor vehicle, for example, can be accommodated in the inner chamber, in particular during a journey of the motor vehicle. The wheel carrier 20 and thus the vehicle wheel 12 are guided to the structure by means of the guide rail in such a way that excessive or unwanted relative movements between the wheel carrier 20 and the structure can be prevented by means of the wheel guide rail. In particular, the wheel guide rail allows compression and rebound movements of the wheel carrier 20 and the vehicle wheel 12 taking place at least in the vertical direction of the vehicle and in relation to the structure. In particular, the wheel carrier 20, in particular the wheel guide rail, can be supported or is supported on the structure here via at least one spring and/or bumper element not depicted in the figures in a spring-loaded and/or dampened manner. Thus, the compression and rebound movements are spring-loaded and/or dampened.

The wheel hub drive 10 has a wheel hub 22, which is rotatably mounted on the wheel carrier 20 via a wheel bearing 24 of the wheel hub drive 10 in such a way that the wheel hub 22 can be mounted rotatably around a wheel axis of rotation 26 in relation to the wheel carrier 20 via the wheel bearing 24 on the wheel carrier 20. The rim 16 is reversibly releasably connected to the wheel hub 22 in a rotationally fixed manner, such that the vehicle wheel 12 is reversibly releasably connected to the wheel hub 22 in a rotationally fixed manner via the rim 16. Thus, the vehicle wheel 12 can rotate together with the wheel hub 22 around the wheel axis of rotation 26 in relation to the wheel carrier 20. In the exemplary embodiment shown in the figures, the wheel bearing 24 is formed as a roller bearing, in particular as a ball bearing, whereby a bearing can be featured that is particularly attrition-free.

In particular, the wheel hub 22 has a rim carrier 28, wherein the vehicle wheel is connected to the rim carrier 28 and thus to the wheel hub 22 in a rotationally fixed manner, in particular reversibly releasably.

Moreover, the wheel hub drive 10 comprises an electric machine 30, which has a stator 32 and a rotor 34. The rotor 34 can be driven by means of the stator 32 and thus can be rotated around an machine axis of rotation 36 in relation to the stator 32 and also in relation to the wheel carrier 20. The machine axis of rotation 36 coincides with the wheel axis of rotation 26, such that, when we speak of the wheel axis of rotation 26 below, this is also to be understood as the machine axis of rotation 36, and vice versa. The rotor 34 is connected at least indirectly to the wheel carrier 20 in a rotationally fixed manner, such that the rotor 34 and the wheel hub 22 can be rotated around the wheel axis of rotation 26 in relation to the wheel carrier 20 and in relation to the stator 32. For example, the stator 32 comprises a stator carrier and at least one or more coils, which are also referred to as stator coils. The rotor 34 comprises, for example, a rotor carrier 38 and magnets 40, which can also be formed, in particular, as permanent magnets. The magnets 40 are held on the rotor carrier 38 and thus are connected to the rotor carrier 38 in a rotationally fixed manner and can thus be rotated with the rotor carrier 38 around the wheel axis of rotation 26 in relation to the wheel carrier 20. In the first embodiment, the rotor carrier 38 and thus the rotor 34 are mounted rotatably on the wheel hub 22 via a rotor bearing 42 provided in addition to the wheel bearing 24, such that the rotor 34, as is explained in yet more detail below, can rotate around the wheel axis of rotation 26 in relation to the wheel hub 22. It is conceivable that the rotor bearing 42 is provided in addition to the wheel bearing 24. In order to be able to achieve a bearing that is particularly free from attrition and thus a particularly high degree of efficiency, the rotor bearing 42 is formed as a further or second roller bearing, in particular as a further or second ball bearing.

Furthermore, the wheel hub drive 10 has a form-fit coupling device 44, which can be switched between a coupling state and a decoupling state. In the coupling state, the rotor 34 is connected to the wheel hub 22 in a form-fit and rotationally fixed manner by means of the coupling device 44, such that when the rotor 34 is driven by means of the stator 32 and is thus rotated around the wheel axis of rotation 26 in relation to the wheel carrier 20, the wheel hub 22 and thus the vehicle wheel 12 rotate with the rotor 34 around the wheel axis of rotation 26 in relation to the wheel carrier 20. Thus, if the rotor 34 is driven by means of the stator 32, while the coupling device 44 is in the coupling state, then the wheel hub 22 and thus the vehicle wheel 12 are thus driven by the stator 32, in particular via the rotor 34. In other words, the vehicle wheel 12 is then driven by means of the electric machine 30. If, in this way, the first vehicle wheel and the second vehicle wheel are driven electrically by means of the wheel hub drives, then, in doing so, the motor vehicle is driven electrically, in particular entirely so, by means of the wheel hub drives. In the decoupling state, however, the rotor 34 can be rotated around the wheel axis of rotation 26 in relation to the wheel hub 22. In other words, the coupling device 44 in the decoupling state allows relative rotations taking place around the wheel axis of rotation 26 between the rotor 34 and the wheel hub 22. Thus, if the vehicle wheel 12 and, with this, the wheel hub 22 connected to the vehicle wheel 12 in a rotationally fixed manner, are rotated around the wheel axis of rotation 26 in relation to the wheel carrier 20, while the coupling device 44 is in the decoupling state, then the wheel hub 22 does not entrain the rotor 34. Thus, excessive entraining losses can be avoided. As can be seen in FIG. 1, the coupling device 44 has a first coupling toothing 46 connected to the rotor 34 in a rotationally fixed manner and a second coupling toothing 48 connected to the wheel hub 22, in particular to the rim carrier 28, in a rotationally fixed manner. In the coupling state, the rotor 34 is connected to the wheel hub 22 in a form-fit and rotationally fixed manner by means of the coupling toothing 46 and 48, such that a particularly high degree of efficiency can be featured. For example, the first coupling toothing 46 is arranged on an end E1 of the rotor 34, in particular the rotor carrier 38, pointing inwards in the axial direction of the wheel hub drive 10, wherein it is conceivable, in particular, that the coupling toothing 46 is arranged on a lateral surface of the rotor 34, in particular of the rotor carrier 38, pointing inwards in the radial direction of the wheel hub drive 10 or even pointing outwards. In particular, the end E1 can be a radially inner end of the rotor 34, in particular the rotor carrier 38. Moreover, the end E1 is an inner end of the rotor 34 when viewed in the axial direction of the wheel hub drive 10, in particular of the rotor carrier 38, such that the coupling toothing 46 is arranged on a side S of the rotor 34, in particular the rotor carrier 38, pointing inwards in the axial direction of the wheel hub drive 10 and thus facing towards an inner region of the motor vehicle.

Furthermore, it can be seen from FIG. 1 that the coupling device 44 has an actuating element 50, which as illustrated in FIG. 1 by arrows 52, can be shifted in the axial direction of the wheel hub drive 10 in relation to the wheel carrier 20, in relation to the rotor 34 and in relation to the wheel hub 22 between at least one coupling position causing the coupling state and at least one decoupling position causing the decoupling state. For example, the coupling device 44 has an actuator 53 depicted schematically, in particular, in FIG. 1, which can be operated electrically, in particular electromagnetically, pneumatically or hydraulically, such that the actuating element 50 can be shifted out of the coupling position into the decoupling position and/or out of the decoupling position into the coupling position electrically, in particular electromagnetically, pneumatically or hydraulically by means of the actuator 53. Thus, the coupling device 44 can be switched particularly efficiently and as needed between the coupling state and the decoupling state.

Furthermore, the wheel hub drive 10 comprises a disc brake 54, which is an operating brake of the motor vehicle and is formed for braking the wheel hub 22 and thus the vehicle wheel 12 and thus the motor vehicle as a whole. The disc brake 54 comprises a brake calliper 56, which is connected to the wheel carrier 20 in a rotationally fixed manner. Moreover, the disc brake 54 comprises a brake disc 58, which is connected to the wheel hub 22 in a rotationally fixed manner, in particular permanently. For this, the wheel hub 22 comprises, for example, a brake carrier 60, which is connected to the rim carrier 28 in a rotationally fixed manner, for example in particular permanently. Here, the brake disc 58 is connected to the brake carrier 60 and thus to the wheel hub 22 in a rotationally fixed manner. The brake disc 58 is connected to the wheel hub 22 in a rotationally fixed manner both in the decoupling manner and in the coupling state, such that the wheel hub 22 and thus the vehicle wheel 12 can be braked by means of the disc brake 54 both in the decoupling state and in the coupling state, in particular with regard to a rotation taking place around the wheel axis of rotation 26 in relation to the wheel carrier 20.

Moreover, it can be easily seen in FIG. 1 that at least one longitudinal region L1 of the wheel bearing 24 running in the axial direction of the wheel hub drive 10 overlaps completely peripherally with the rotor bearing 42 outwardly in the radial direction of the wheel hub drive 10 in the peripheral direction of the wheel hub drive 10 running around the wheel axis of rotation 26, i.e., is covered by it, whereby a particularly compact and efficient structure can be featured. Furthermore, it can be seen that the rotor bearing 42 is supported outwardly in the radial direction of the wheel hub drive 10 directly on the rotor 34, in particular on the rotor carrier 38, and inwardly in the radial direction of the wheel hub drive 10 directly on the wheel hub 22, in particular on the rim carrier 28.

Moreover, in the exemplary embodiments shown in the Figures and thus optionally, the wheel hub drive 10 comprises a power electronics system 62, via which the electric machine 30 can be supplied with electrical energy, in particular electrical current. Optionally, the power electronics system 62 is connected to the wheel carrier 20 in a rotationally fixed manner. It can be seen from FIG. 1 that the power electronics system 62 is covered at least partially, in particular at least extensively and thus at least by more than half or even completely, by the wheel hub 22, in particular by the brake carrier 60, for example outwardly in the radial direction of the wheel hub drive 10. When seen in the axial direction of the wheel hub drive 10 and thus along the wheel axis of rotation 26, the brake disc 58, the power electronics system 62 and the stator 32 are arranged in the following order, for example, in particular when seen from the inside to the outside: the brake disc 58, the power electronics system 62 and the stator 32. In order to switch the coupling device 44, for example, out of its decoupling state into its coupling state, i.e., to close it, the actuation element 50, for example, is shifted outwardly in the axial direction of the wheel hub drive 10. In order to switch the coupling device 44, for example, out of its coupling state into its decoupling state and thus to open it, the actuation element 50, for example, is shifted inwardly in the axial direction of the wheel hub drive 10. The coupling state is also referred to as the closed state, wherein the decoupling state is also referred to as the open state.

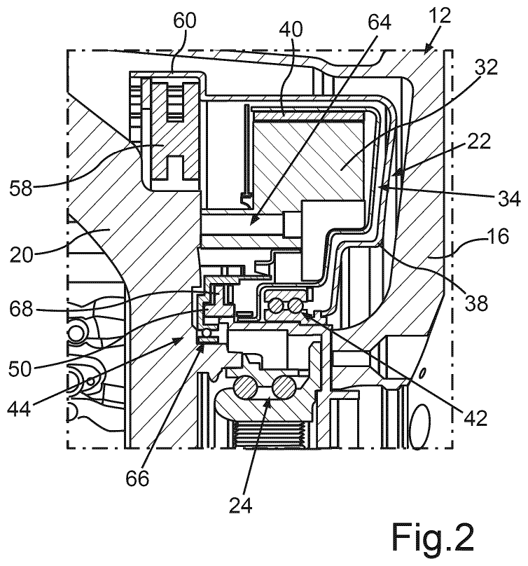

It can be seen from FIG. 2 that the stator 32 is formed separately from the wheel carrier 20, for example, and is connected to the wheel carrier 20 by means of at least one stator screw 64 and is thus connected to the wheel carrier 20 in a rotationally fixed manner. The brake carrier 60 has, for example, a lamella toothing, by means of which the brake carrier 60 is connected to the brake disc 58 in a rotationally fixed manner. The lamella toothing is also referred to as the first lamella toothing. For example, the brake disc 58 has a second lamella toothing corresponding to the first lamella toothing, wherein the lamella toothings are connected to each other, in particular in a rotationally fixed and/or form-fit manner, such that the brake carrier 60 is connected to the brake disc 58 by means of the lamella toothing in a rotationally fixed manner, in particular in a form-fit and rotationally fixed manner, and vice versa. For example, the actuation element 50 is a clutch controller and is also referred to as the clutch controller. Here, a clutch controller bearing 66, also simply referred to as a bearing, can be seen in FIG. 2, via which the clutch controller (actuation element 50) is mounted on the wheel carrier 20, in particular in a rotationally fixed manner, but in such a way that the clutch controller can be shifted axially as described. In particular, a linear actuation of the clutch controller and thus the coupling device 44 can be represented by a rotational movement of the clutch controller. For this, the actuator is represented as a rotational actuator, for example. In other words, the actuation element 50, for example, can be rotated by means of the actuator, in particular in relation to the wheel carrier 20, whereby a translational movement taking place in the axial direction of the wheel hub drive 10 in relation to the wheel carrier 20, in relation to the wheel hub 22 and in relation to the rotor 34 and thus a shifting of the actuation element 50 can be caused or is caused. For this, the rotation of the clutch controller that can be caused or is caused, for example, by means of the actuator and taking place in relation to the wheel carrier 20 is converted into a shifting of the clutch controller taking place in the axial direction of the wheel hub drive 10 in relation to the wheel carrier 20. As a result of this shifting of the clutch controller, the initially opened coupling device 44, for example, is closed and/or vice versa.

For example, a rotational speed decoupling of the actuation element 50 is provided. The rotational speed decoupling can be understood, in particular, to mean as follows: the actuation element 50 has, for example, at least or exactly two actuation parts, namely a first actuation part and a second actuation part. The first actuation part, for example, is connected to the wheel carrier 20 in a rotationally fixed manner, and thus held on the wheel carrier 20 in such a way that relative rotations taking place around the wheel axis of rotation 26 between the first actuation part and the wheel carrier 20 cease. For example, the first actuation part is the clutch controller mentioned above. The second actuation part is, for example, a sliding bushing. The second actuation part, for example, is connected to the rotor 34 in a rotationally fixed manner, and thus can be rotated with the rotor 34 around the wheel axis of rotation 26 in relation to the wheel carrier 20 and thus also in relation to the first actuation part. The actuation parts can thus be rotated in relation to each other around the wheel axis of rotation 26, however, in particular in the axial direction of the wheel hub drive 10, coupled to each other in such a way that a shifting of the first actuation part taking place in the axial direction of the wheel hub drive 10 in relation to the wheel carrier 20, in relation to the wheel hub 22 and in relation to the rotor 34 leads to a shifting of the second actuation part taking place in the axial direction of the wheel hub drive 10 in relation to the wheel carrier 20, in relation to the wheel hub 22 and in relation to the rotor 34. Thus, the actuator, for example, can be mounted on the wheel carrier 20, in particular in a rotationally fixed manner. If the first actuation part is shifted in the axial direction of the wheel hub drive 10 in relation to the wheel carrier 20, in relation to the wheel hub 22 and in relation to the rotor 34 by means of the actuator, then, in doing so, the second actuation part is shifted via the first actuation part in the axial direction of the wheel hub drive 10 in relation to the wheel carrier 20, in relation to the rotor 34 and in relation to the wheel hub 22. In doing so, the actuation parts and thus the actuation element 50 are shifted in the axial direction of the wheel hub drive 10 between the decoupling position and the coupling position, in order to thus be able to switch the coupling device 44 as needed between the coupling position and the decoupling position. The brake carrier 60 or the wheel hub 22 have, for example, a hub 68 having a catch or entrainment toothing.

In particular, the bearing of the rotor 34 via the rotor bearing 42 on the wheel hub 22, in particular on the brake carrier 60, allows for an arrangement of the coupling device 44, preferably formed as a claw coupling, on a vehicle side of the rotor 34, and thus on the side S of the rotor 34 pointing inwardly in the axial direction of the wheel hub drive 10 and thus facing towards the inner region of the motor vehicle, whereby the coupling device 44 is particularly advantageously accessible for the actuator, also referred to as the actuation, namely from the side S.

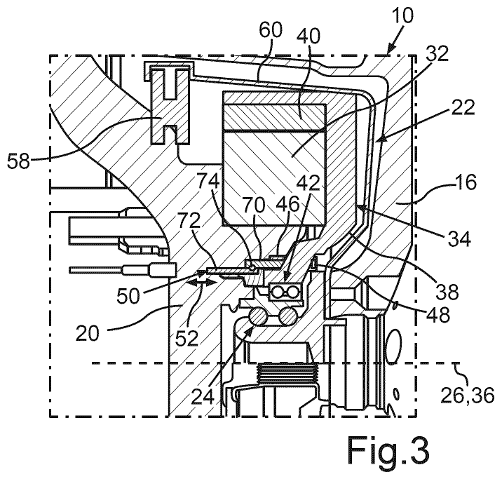

FIGS. 3 to 8 show a second embodiment of the wheel hub drive 10. The second embodiment shown in FIGS. 3 to 8 does not appertain to the invention. The second embodiment differs, in particular, from the first embodiment in that, in the second embodiment, the rotor 34, in particular the rotor carrier 38 and thus the rotor 34, is rotatably mounted via the rotor bearing 42 on the wheel carrier 20. Thus, for example, the rotor bearing 42 is supported outwardly in the radial direction of the wheel hub drive 10 directly on the rotor 34, in particular on the rotor carrier 38, wherein, for example, the rotor bearing 42 is supported outwardly in the radial direction of the axle drive 10 directly on a lateral surface of the rotor 34, in particular of the rotor carrier 38, on the side of the inner periphery. Inwardly in the radial direction of the wheel hub drive 10, the rotor bearing 42 is supported directly on the wheel carrier 20, in particular on a lateral surface of the wheel carrier 20 on the side of the outer periphery. However, the following statements relating to the second embodiment, in particular in relation to the actuation element 50 and the coupling device 44 and here, in particular, in relation to their actuation, can be transferred to the first embodiment.

The stator 32 and the rotor 34 with the rotor carrier 38 and the magnets 40 can be seen particularly well in FIG. 3. It can be seen that the stator 32 is overlapped at least partially by the stator 32 outwardly in the radial direction of the wheel hub drive 10. It can be seen particularly well in FIG. 3 that the second actuation part formed, for example, as a sliding bushing and labelled with 70 in FIG. 3, engages through the rotor carrier 38 and here has a claw, for example, which, in the coupling state, interacts with the corresponding second coupling toothing 48 of the wheel hub 22. Furthermore, the claw interacts with the corresponding first coupling toothing 46 of the rotor 34, for example at least in the coupling position or in the coupling state, in particular both in the coupling state and in the decoupling state, such that, in the coupling state, the rotor 34 is connected by means of the claw and by means of the coupling toothing 46 and 48 to the wheel hub 22 in a form-fit and rotationally fixed manner, or vice versa. As is illustrated by arrow 52, the first actuation part labelled with 72 in FIG. 3 and formed, for example, as a clutch controller is shiftably held on the wheel carrier 20 in the axial direction of the wheel hub drive 10 in relation to the wheel carrier 20. For example, the actuation part 70 rotates both in the coupling state and in the decoupling state along with the rotor 34. The rotational speed decoupling comprises, for example, roller bodies 74, which allow relative rotations taking place around the wheel axis of rotation 26 between the actuation parts 70 and 72, but the actuation parts 70 and 72 couple to each other in such a way that the actuation part 70 can be shifted by shifting the actuation part 72. Thus, the actuation parts 70 and 72 and thus the actuation element 50 can be actuated linearly, i.e., in the axial direction of the wheel hub drive 10, in particular in relation to the wheel carrier 20, i.e., can be shifted, such that they rotate in relation to one another around the wheel axis of rotation 26.

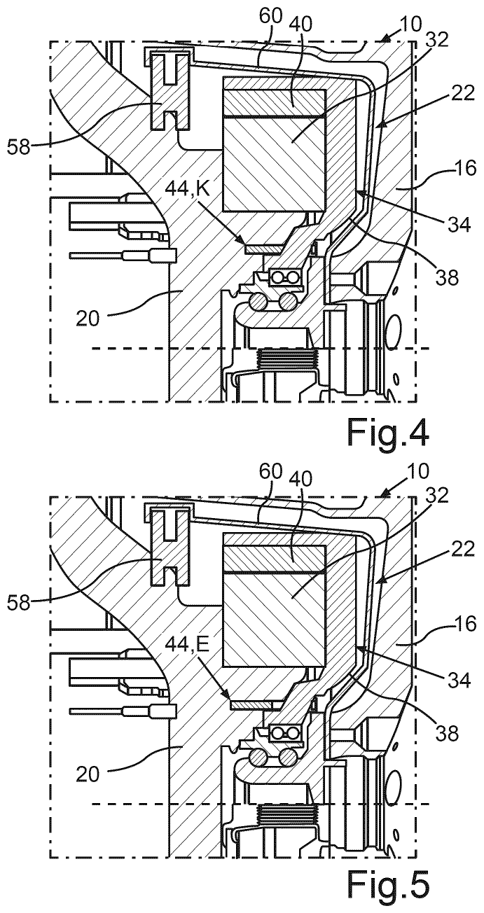

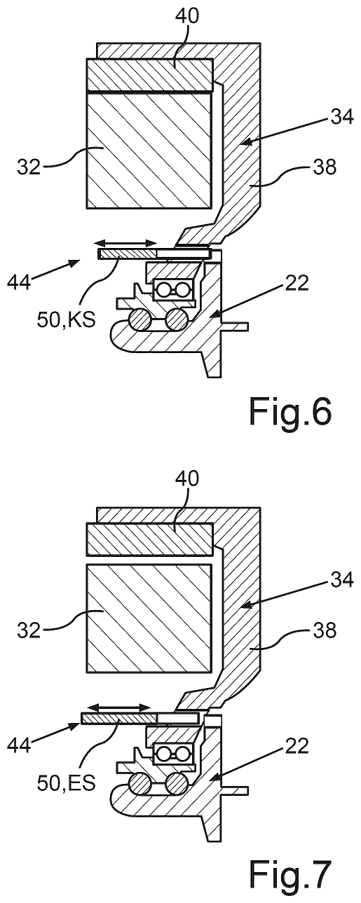

FIG. 4 shows the coupling device 44 in the coupling state labelled with K in FIG. 4, such that the coupling device 44, also referred to as the coupling, is closed. For example, the actuation element 50 or the actuation part 70 is formed as a claw, in particular as a claw ring. FIG. 5 shows the coupling device 44 in the decoupling state, labelled with E. FIG. 6 shows the actuation element 50 in the coupling position KS, such that the coupling device 44 is in the coupling state. FIG. 7 shows the actuation element 50 in the decoupling position ES, such that the coupling device 44 is in the decoupling state.

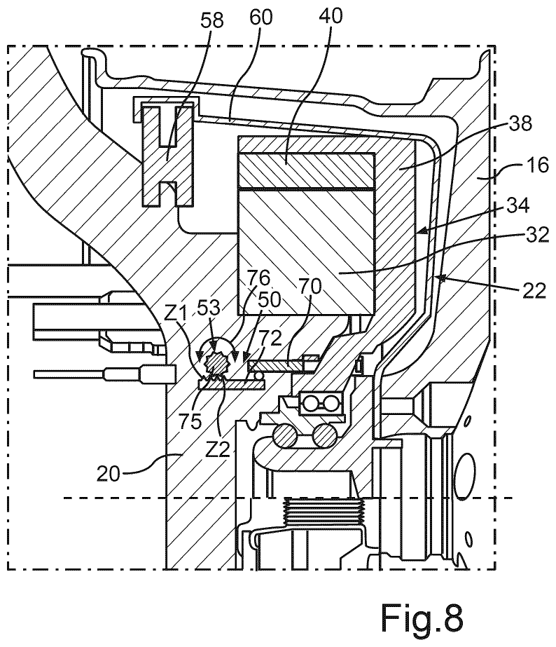

Finally, FIG. 8 shows the wheel hub drive 10 in sections in a further schematic longitudinal section view. It can be seen from FIG. 8 that the actuation parts 70 and 72 and thus the actuation element 50 can be shifted, for example, in the axial direction of the wheel hub drive 10 in relation to the wheel carrier 20, in relation to the rotor 34 and in relation to the wheel hub 22 in such a way that the actuation part 72 has a first toothing Z1. To do so, for example, the actuation part 72 is formed as a first tooth rod. The actuator 53 has, for example, a tooth wheel 75, which can be rotated around an axis of rotation in relation to the wheel carrier 20. The axis of rotation runs, for example, perpendicularly to the axial direction of the wheel hub drive 10. The tooth wheel 75 has a second toothing Z2 corresponding to the toothing Z1, which engages in the corresponding toothing Z1. If, as is illustrated by a double arrow 76, the tooth wheel 75 rotates to and fro, then the actuation part 72 and, via this, the actuation part 70 are thus shifted to and fro in the axial direction of the wheel hub drive 10 in relation to the wheel carrier 20, whereby the actuation element 50 can be shifted between the decoupling position ES and the coupling position KS. For example, the actuator 53 comprises an electric machine, by means of which the tooth wheel 75 can be rotated to and fro as needed. Thus, the coupling device 44 can be switched between the coupling state and the decoupling state as needed. For example, the roller bodies 74 are roller bodies of a grooved ball bearing, by means of which the rotating decoupling is featured.

In the exemplary embodiment shown in FIG. 8, the actuator 53 is formed as a rotary plate, in particular as an electric rotary plate. It would be further conceivable that the actuator 53 is a linear plate, the rotors of which cannot be rotated in relation to the wheel carrier 20, but rather can be shifted in relation to the wheel carrier 20. Furthermore, it would be conceivable that the actuator 53 has a piston or is a piston, can be shifted translationally, for example, in relation to the wheel carrier 20, in order to thus translationally move, and thus to shift, the actuation element 50.

### List of Reference Characters

10 Wheel hub drive
12 Vehicle wheel
14 Ground
16 Rim
18 Tyre
20 Wheel carrier
22 Wheel hub
24 Wheel bearing
26 Wheel axis of rotation
28 Rim carrier
30 Electric machine
32 Stator
34 Rotor
36 Machine axis of rotation
38 Rotor carrier
40 Magnet
42 Rotor bearing
44 Coupling device
46 First coupling toothing
48 Second coupling toothing
50 Actuation element
52 Arrow
53 Actuator
54 Disc brake
56 Brake calliper
58 Brake disc
60 Brake carrier
62 Power electronics system
64 Stator screw
66 Clutch controller bearing
68 Hub
70 Actuation part
72 Actuation part
74 Roller body
75 Tooth wheel
76 Double arrow
E Decoupling state
ES Decoupling position
K Coupling state
KS Coupling position
L1 Longitudinal region
S Side
Z1 First toothing
Z2 Second toothing

1.-10. (canceled)

11. A wheel hub drive (10) for a motor vehicle, comprising:
a wheel carrier (20);
a wheel hub (22) rotatably mounted on the wheel carrier (20) via a wheel bearing (24), wherein a vehicle wheel (12) of the motor vehicle is connectable in a rotationally fixed manner to the wheel hub (22);
an electric machine (30) which has a stator (32) connected to the wheel carrier (20) in a rotationally fixed manner and has a rotor (34) that is drivable via the stator (32) and is rotatable in relation to the stator (32), wherein the rotor (34) is mounted rotatably on the wheel hub (22) via a rotor bearing (42); and
a coupling device (44) which is switchable between a coupling state (K) in which the rotor (34) is connected to the wheel hub (22) in a form-fit and rotationally fixed manner via the coupling device (44) and a decoupling state (E) in which the rotor (34) is rotatable in relation to the wheel hub (22).

12. The wheel hub drive (10) according to claim 11, wherein the coupling device (44) has a first coupling toothing (46) connected to the rotor (34) in a rotationally fixed manner and a second coupling toothing (48) connected to the wheel hub (22) in a rotationally fixed manner and wherein, in the coupling state (K), the rotor (34) is connected to the wheel hub (22) via the first coupling toothing (46) and the second coupling toothing (48) in a form-fit and rotationally fixed manner.

13. The wheel hub drive (10) according to claim 12, wherein the first coupling toothing (46) is disposed on a radially inner end (E1) and axially on a side(S) of the rotor (34) facing towards an inner region of the motor vehicle.

14. The wheel hub drive (10) according to claim 11, further comprising a brake disc (58) connected to the wheel hub (22) in a rotationally fixed manner.

15. The wheel hub drive (10) according to claim 11, wherein at least one longitudinal region (L1) of the wheel bearing (24) running in an axial direction of the wheel hub drive (10) is overlapped by the rotor bearing (42) outwardly in a radial direction of the wheel hub drive (10).

16. The wheel hub drive (10) according to claim 11, wherein the rotor bearing (24) is supported outwardly in a radial direction of the wheel hub drive (10) directly on the rotor (34) and inwardly in the radial direction of the wheel hub drive (10) directly on the wheel hub (22).

17. The wheel hub drive (10) according to claim 11, wherein the coupling device (44) has an actuating element (50) that is shiftable in an axial direction of the wheel hub drive (10) in relation to the wheel carrier (20), in relation to the rotor (34), and in relation to the wheel hub (22) between at least one coupling position causing the coupling state (K) and at least one decoupling position(ES) causing the decoupling state (E).

18. The wheel hub drive (10) according to claim 17, wherein the coupling device (44) has an actuator (53) via which the actuation element (50) is shiftable out of the coupling position (K) into the decoupling position(ES) and/or out of the decoupling position(ES) into the coupling position (KS) electrically or electromagnetically or pneumatically or hydraulically.

19. The wheel hub drive (10) according to claim 11, further comprising a power electronics system (62) via which the electric machine (30) is supplyable with electrical energy, wherein the power electronics system (62) is connected to the wheel carrier (20) in a rotationally fixed manner.

20. A motor vehicle, comprising:
the wheel hub drive (10) according to claim 11.
